(19) United States
(12) Patent Application Publication
(10) Pub. No.: US 2004/0031049 A1
(43) Pub. Date: Feb. 12, 2004

(54) Server and computer program for the server

(76) Inventors: Yoshinori Suzuki, Saitama (JP); Shigehisa Motowaki, Hitachi (JP); Takeshi Hoshino, Kodaira (JP); Junji Nakata, Sagamihara (JP); Hiroshi Akai, Hujisawa (JP)

Correspondence Address: Mattingly, Stanger & Malur, P.C., Suite 370, 1800 Diagonal Road, Alexandria, VA, 22314, US

(21) Appl. No.: 10/372,920

(22) Filed: Feb. 26, 2003

(30) Foreign Application Priority Data
Aug. 6, 2002 (JP) 2002-228096

(51) Int. Cl. G06F 3/00; H04N 5/445; G06F 13/00; H04N 7/18; H04N 7/00; H04N 11/00

(52) U.S. Cl. 725/39; 725/80; 348/552

(57) ABSTRACT

Multi-camera signal distribution conducted by a plurality of broadcasters has various problems of charging, video switching and copyright from the user's viewpoint. In order to solve these problems, first, a charging unit is provided for charging at a measured-rate charging to the assessment price of contents. Secondly, a program scramble is used to encrypt the whole service and a show scramble to encrypt each show, or each channel, thus making it possible to offer service according to the conditions of a contract the viewer made. Third, a show selection unit is provided to select shows on a show selection guide picture displayed on the screen of a communication terminal that has a remote control function. Use of this charging system could prevent the total amount of charging from increasing even if channels to view are frequently changed.

### BACKGROUND OF THE INVENTION

The present invention relates to a technical field of data delivery.

A multi angle television system for the delivery and display of multi-camera video images is proposed, as disclosed in JP-A-05-130528, in order that the radio waves of video signals taken from various angles of view can be displayed at a desired angle of view.

A method of selection/charging of contents by use of a portable terminal and a receiving terminal is disclosed in JP-A-2001-103020, in which the portable terminal selects and registers desired contents and receives necessary information for acquiring the contents, and the receiving terminal acquires/decodes the contents. More specifically, first the portable terminal makes the selection/registration of desired source files on the basis of catalog information that the receiving terminal has received through broadcasting channels. Second, the portable terminal obtains cryptograph information and time information necessary for the download, and the receiving terminal is used to download the desired source files. The receiving terminal is connected to the broadcasting channels that distribute the catalog and source files, and the portable terminal is connected to the database that manages the charging information and download management information.

### SUMMARY OF THE INVENTION

The service for distributing multi-camera video images such as multi-angle video images or multi-scene video images could accept the request to freely change channels as time goes on. However, in the conventional content-unit charging system, the selected contents are all charged. Thus, if two or more contents are selected at a time, the camera video images currently not displayed are also charged.

In the multi-camera broadcasting system in which a plurality of broadcasters participate, the copyright holder and billing party of a channel are supposed to be different from those of other channels, however the TV viewer does not always make agreements with all the broadcasters that participate in the multi-camera broadcasting system. In addition, it can be supposed that each broadcaster manages copyrights in a different way. In that case, since the way to offer services seems to depend on the agreement between the service supplier and the broadcaster, it is necessary to have a mechanism for limiting the channels that the TV viewer can view according to the agreement conditions. Moreover, when the maintenance company that offers the measured-rate charging service is different from the broadcast communication service provider that transmits signals, it is also necessary to have a mechanism for defining the service area in two organizations, and the companies that the viewer pays for the broadcast content distribution service and charge/selection support service.

The multi-video distribution service needs a scheme for treating a plurality of camera images as one show and for the viewer to switch video images on the basis of their preference. Also, it would be ideal to have the situations where the viewer can be informed of the change of broadcasting schedule. To this end, it is necessary to provide means not only for acquiring information in advance but also for obtaining latest information one after another.

To solve these problems, the invention first proposes means for measured-rate charging based on the assessed value of content. More specifically, a time-unit rate is provided for each of contents, and an amount of charging is computed from the integration of the time-unit rate for that content and the viewing time. Thus, it is possible to resolve the contradiction that the viewer must pay much viewing fee for the content the user viewed for a short time.

Secondly, the present invention suitably employs a program-scramble to the whole service and a show-scramble to each show or channel, thus making it possible to offer service according to the situations in which the viewer has contacted. Specifically, the program-scramble restricts the use of the measured-rate charging service, and the show-scramble limits the use of each broadcast channel. According to this stepped scramble approach, even if the multi-camera broadcasters include a noncontractual one, the usual show-scramble limits the use of that channel, so that the program-scramble can only restrict the use of whole service. Also, according to this method, when the maintenance company for offering the measured-rate charging service is different from the broadcast communication service provider that transmits signals, it is possible to define the service area in the two bodies and the companies that the viewer pays for the broadcast content distribution service and charge/selection support service. Moreover, the show-scramble scheme can be used common to the broadcasters, this system is easy to apply.

Thirdly, according to the invention, means for receiving a show-selection guide picture and selecting shows is provided in a communication terminal that has a remote-control function and a communication function. Specifically, this communication terminal is used to convert the show contents into selected channels, and transmit the selected-channel information to each of the show data receiving terminal and charging server. By this control, it is possible to offer multi-camera broadcasts as a pseudo single-show to the viewers.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing the whole construction for the measured-rate charging service and show selection support service according to the invention.

FIG. 2 is a diagram showing an example of the basic structure of a data processor.

FIGS. 3A-3C are diagrams showing examples of the arrangement of multiple cameras.

FIGS. 4A and 4B are diagrams showing examples of selection guide picture data and a show-charge corresponding list in real time selection mode.

FIGS. 5A-5G are diagrams showing examples of the selection guide pictures in real time selection mode.

FIGS. 6A-6F are diagrams showing examples of the selection guide pictures and automatic ch charging conversion list in a cross-sectional show formation mode.

FIGS. 7A and 7B are diagrams showing examples of the selection guide picture and show-table/charging list in a customized show formation mode.

FIG. 8 is a flowchart showing the flow of service in data center.

FIG. 9 is a flowchart showing the flow of the whole process in a radio terminal with remote control function.

FIG. 10 is a flowchart showing the flow of change requesting process in the radio terminal with remote control function.

FIG. 11 is a flowchart showing the flow of service start/authentication process in the radio terminal with remote control function.

FIG. 12 is a flowchart showing the flow of guide picture selection process in the radio terminal with remote control function.

FIG. 13 is a flowchart showing the flow of show selection process in the radio terminal with remote control function.

FIG. 14 is a flowchart showing the flow of update program process in the radio terminal with remote control function.

FIG. 15 is a flowchart showing the flow of automatic show selection process in the radio terminal with remote control function.

FIG. 16 is a flowchart showing the flow of descramble and data reconstruction in TV receiver.

FIG. 17 is a flowchart of an example of command list production for simultaneous recording of a plurality of camera signals.

FIGS. 18A and 18B are diagrams showing other structures of the terminal system for receiving the service of multi-camera video signal distribution.

### DESCRIPTION OF THE EMBODIMENTS

A description will be made of embodiments of (1) specific, or measured-rate (integration of the time-unit rate and viewing time for content) charging process for a plurality of shows, (2) stepwise scramble (proper use of program scramble and show scramble) and (3) channel selection support using selection guide pictures in the multi-camera broadcasting using a plurality of broadcast channels. The multi-camera (multi-channels) broadcasting system in the embodiments of the invention is assumed to be a single show-program that occupies a plurality of channels as normal individual broadcasts. Thus, the show genre, tie-up production, and broadcast right are altered one after another. Specifically, settings of “camera angle and formation of channels” “combination and number of channels to view”, “content price of each camera signal (variable with time even within a single show), and “combination of broadcasting stations having broadcast right” are updated successively. Therefore, in order for the viewer to enjoy such a multimedia broadcast, the terminals and the server connecting the viewers to the broadcasting side need the functions to “compute the total amount of charging for the multi-channels broadcasting system”, “scramble all the shows”, and “update the show selection support program including conversion between channel and show in real time”. These intermediate functions makes it possible that the information to be given to the viewers (radio terminals with remote control function) is limited to show-contents and charging information, the information given to TV receiver is limited to selected channel and descramble data, and the information given to charging server is limited to identification information and channel-selection information of each user, thus complying with various combinations of broadcast schedules. The technique of this invention can be applied not only to the case where a single event like baseball is shot by a plurality of cameras, but also to the cases when the contents are branched by selection like a scene-selection type drama having a multi-angle structure, when competitive sports conducted in parallel in a single stadium like athletic sports are picked up by a plurality of cameras, and when competitive sports held in parallel in different sites like Olympic are shot by a plurality of cameras. The present invention, as mentioned above, can be applied to the TV show the associated contents of which are broadcast on a plurality of channels.

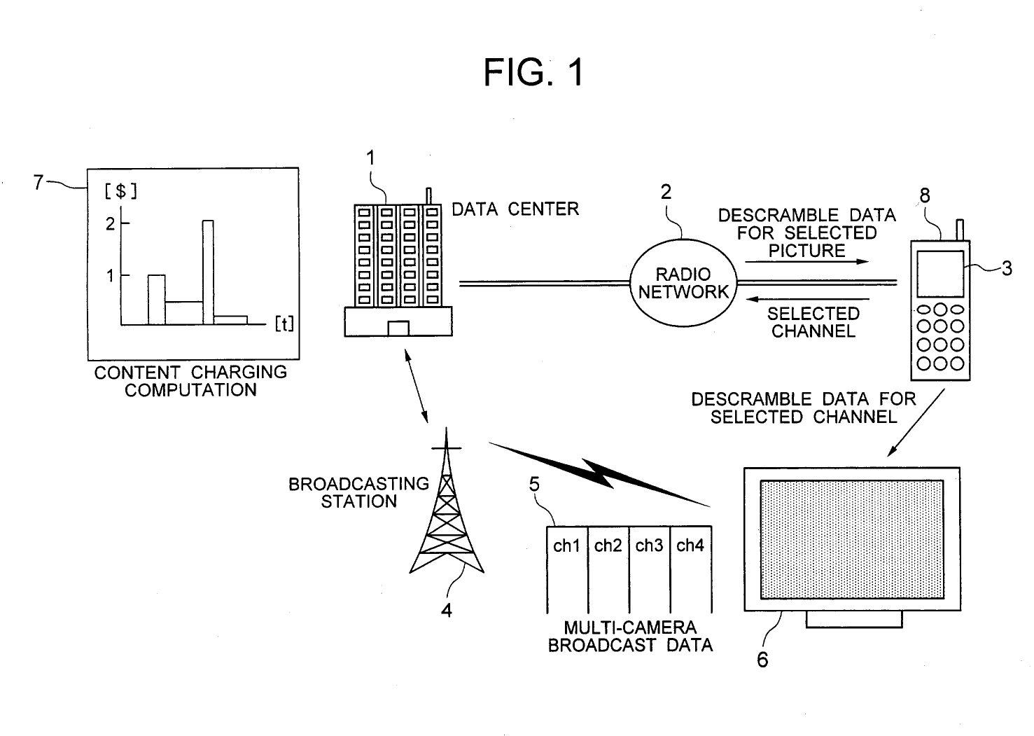

The flow of information in this multi-camera broadcasting will be first described. FIG. 1 shows the whole system for the multi-camera broadcasting. A data center 1 holds customer information and management data for broadcast contents, and serves to control the whole service for the multi-camera broadcasting so that charging process for multi-channel system and show selection service can be made and offered to each customer. This data center 1 is connected through a radio communication network 2 to a radio terminal with remote control function 8 of each contractant. The radio terminal with remote control function 8 receives selection guide picture data for use in the show selection support service to the user, and additional data including charging information and channel information, and it generates a selection guide picture and displays it on a screen 3. Two receiving methods can be considered; a method where both data are received by radio communication, and the other method where the additional data is received by radio communication while the selection guide picture data is received as broadcast media. Then, as the viewer inputs information, the radio terminal with remote control function 8 transmits channel information (selected-channel information) corresponding to the selected show to data center 1. The data center 1 that has received the selected-channel information transmits, descramble data that is used to view the show that this customer selected, to the terminal 8. At the same time, the data center 1 updates the charging data of this customer on the basis of the received selected-channel information. A graph 7 shows an example of the charging computation in which the viewing fee of the customer is computed from the integration of the time-unit content rate and viewing time corresponding to the selected channel information transmitted from the viewer. The radio terminal with remote control function 8 that has received the descramble data transmits the selected channel information and descramble data to a television receiver 6. On the other hand, the data center 1 transmits and receives information to and from a broadcasting station 4 so that the latest broadcast schedule can always be reflected on the show selection service. The broadcasting station 4 televises scrambled multi-camera broadcast data 5 according to the broadcasting schedule provided to the data center 1. The term, broadcasting station given above, is used to include a content production agency that edits and supplies the show of respective channels, and an agency (sometimes formed of two or more organizations) that multiplexes and distributes a transmission signal of a plurality of channels. However, in case that the data center is operated by the agency that makes the multiplex process and distribution or in case that the data center makes the multiplex process and distribution, the data multiplexing process can be considered not to be performed in broadcasting station 4 but in data center 1. Moreover, in this case, we assume that the multi-camera broadcast data 5 is distributed from the data center, and considers the broadcasting station 4 as the generic name of a plurality of content production organizations that form and offer shows. The TV receiver 6 outputs video images and audio sound on the basis of the multi-camera broadcast data, and the selected channel information and scramble data received from the radio terminal.

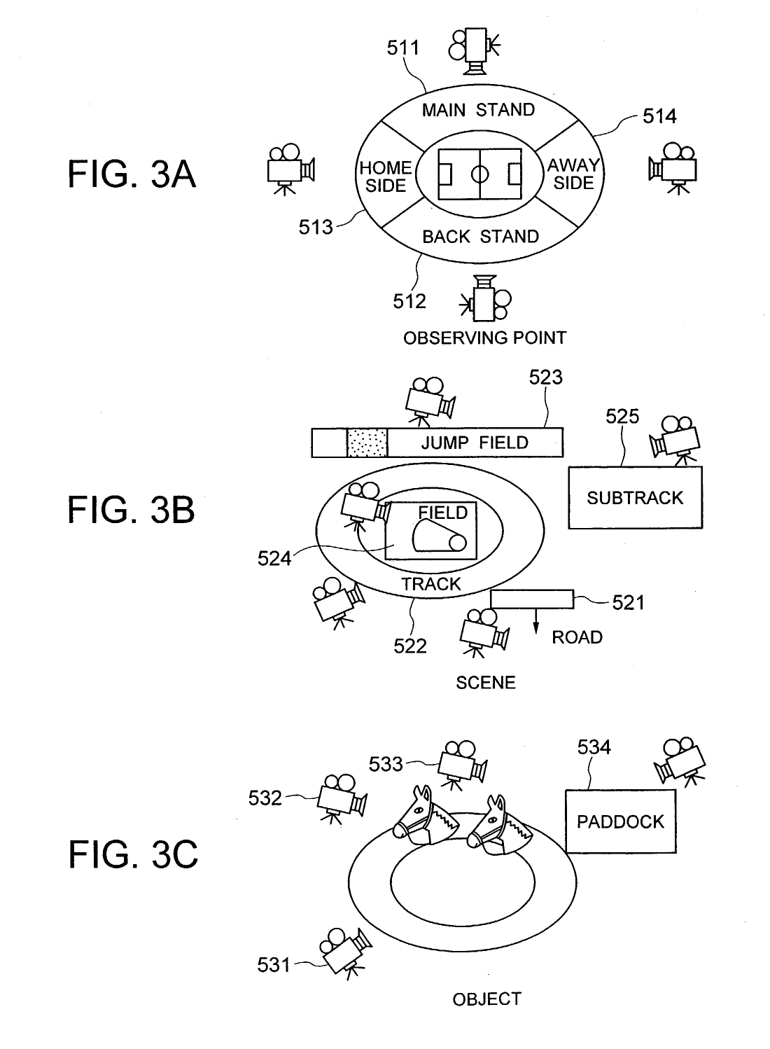

FIGS. 3A-3C show examples of the arrangement of multiple cameras; FIG. 3A shows an example of shooting a single event by a plurality of cameras, FIG. 3B an example of shooting competitive spots played in parallel in one site, and FIG. 3C an example of shooting a plurality of objects appearing in one event by the respective cameras. The video images produced from the cameras 511-514, 521-525 or 531-534 are delivered on channels, respectively.

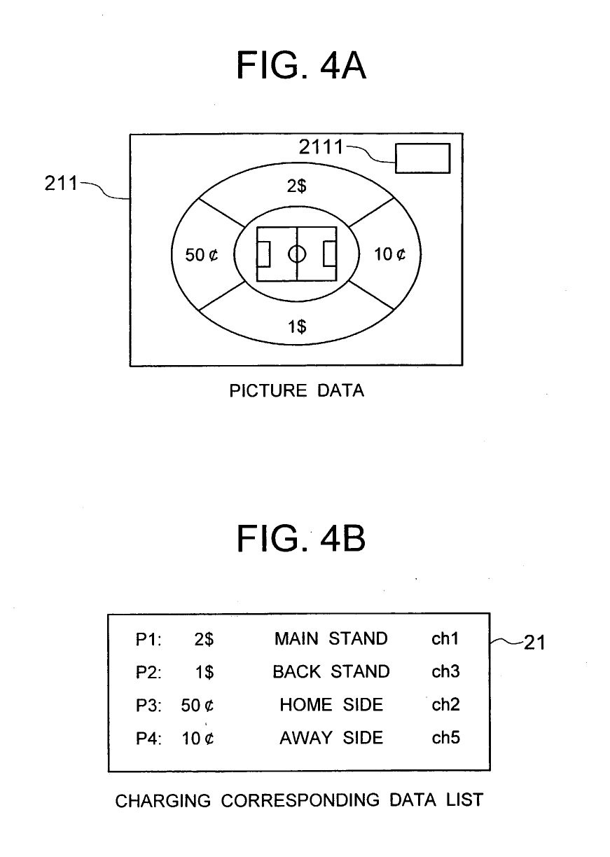

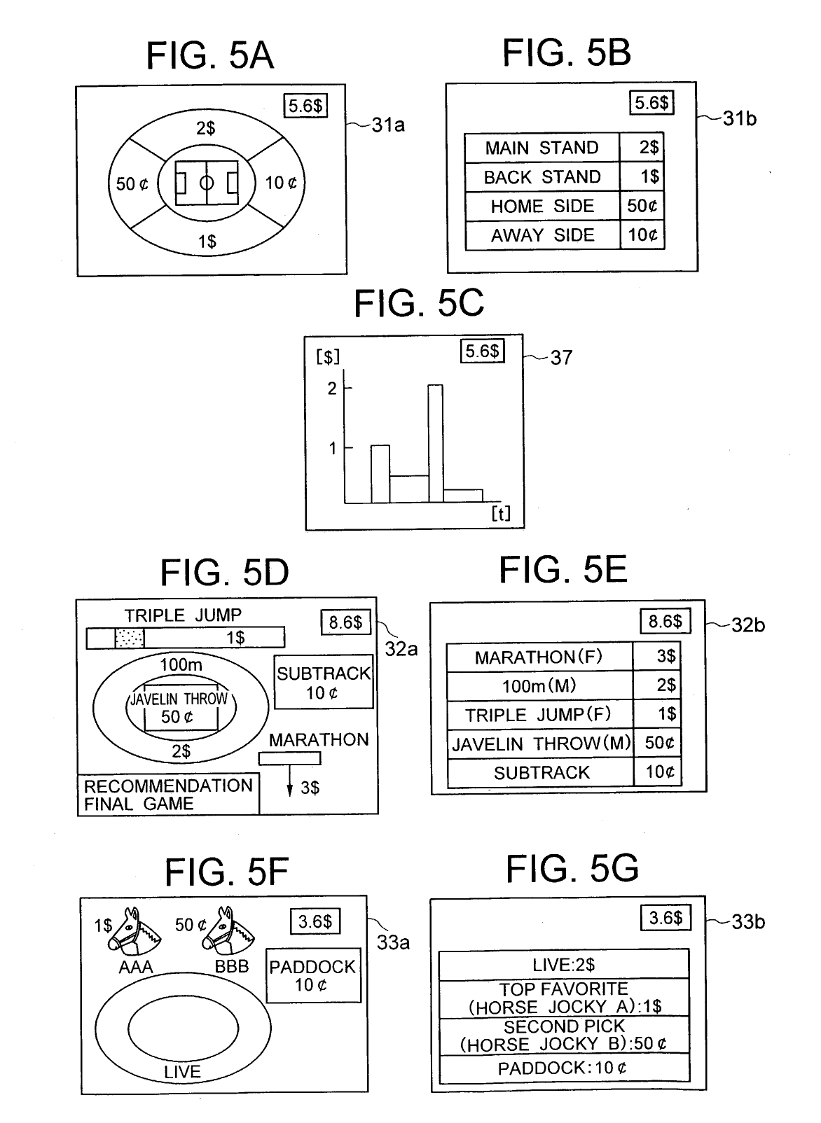

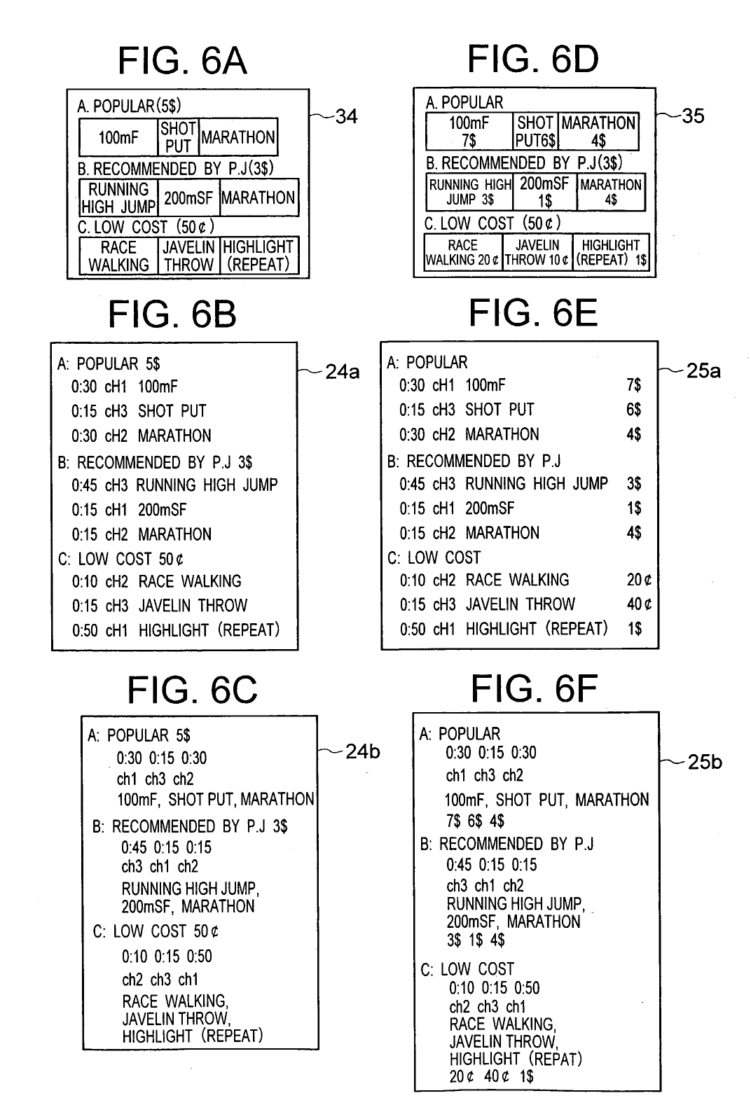

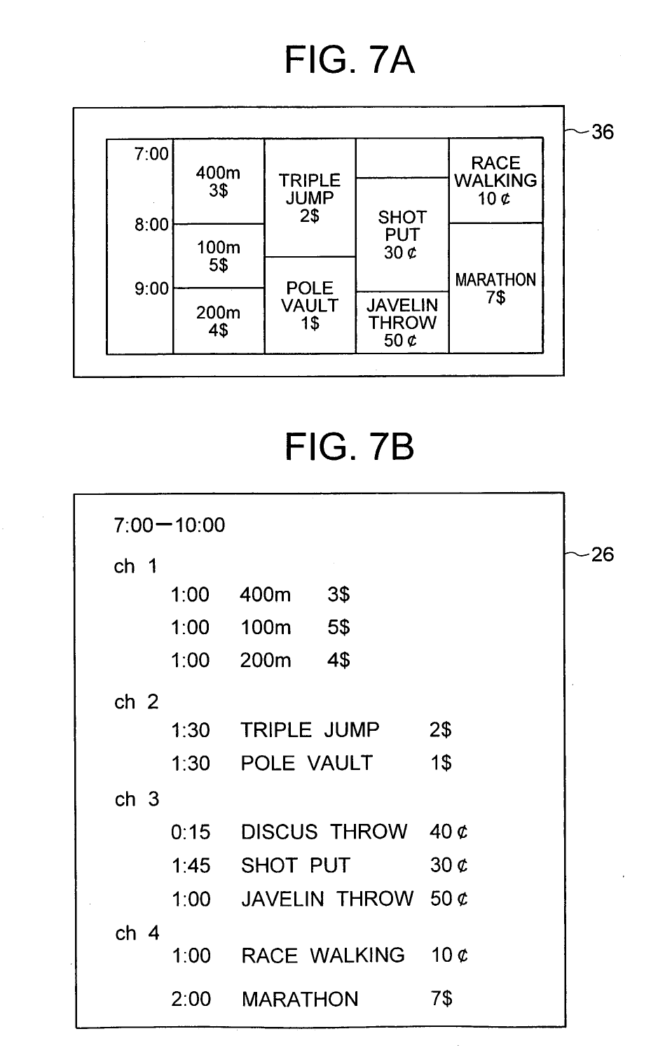

FIGS. 4-7 show examples of selection guide picture data and additional data (of which the contents depend on the format of selection guide picture) that the radio terminal with remote control function 8 acquires from the data center 1, and examples of the format of selection guide pictures generated from these data. The kinds, or formats of selection guide pictures can include (1) real time selection, (2) cross-sectional show formation, (3) customized show formation, and (4) search show formation. In either case, this invention offers schemes that make it possible that the viewer selects the show depending not only on the channel number but also on contents and viewing fee, in other words the scheme that convert the show contents and viewing fee into channel numbers is offered. The real time selection is the method for switching the broadcast scenes or shows by the viewer's selection. FIGS. 4A and 4B respectively show the selection guide picture data and show-charge corresponding data list (additional data) as an example of the real-time selection mode in which one of audience seats is selected. FIGS. 5A-5C shows examples of the selection guide picture of this mode. The selection guide picture data, 211 includes data of a shape selection guide picture and a space 2111 for the total amount of viewing fee. The program for producing a picture from data 211 may be JAVA (trademark or registered trademark of Sun Microsystems, Inc. in USA), HTML, XML, or MP4 (MPEG-4 FILE FORMAT). Reference characters P1-P4 indicate four candidates which are described as time-unit viewing rate of contents, show contents or channel numbers in the show-charge corresponding data list of FIG. 4B. The show-charge corresponding data list, 21 of FIG. 4B describes the content titles, time-unit rate for that content, channel numbers and the numbers corresponding to those in the selection guide picture. Reference numerals 31a, 31b and 37 of FIGS. 5A-5C designate examples of selection guide picture format; 31a shows a visual representation, 31b a list representation, and 37 a charging graph representation, which can be freely switched by the viewer. The time-unit rates of the visual representation 31a can be switched to the content titles, channel numbers or combinations of these pieces of information as shown in FIG. 4B. FIGS. 5D-5G show examples of selection guide picture format in the real-time selection mode where scenes (competitive sports) and objects are used as candidates of selection. Reference numerals 32a and 33a denote visual representation, and 32b and 33b are list representation. Also, indicated at 32a and 33a are examples of simultaneous representation of content time-unit rate and content titles. FIGS. 6A-6F show examples of selection guide picture format and automatic CH-charge conversion list (additional data) in the cross-sectional show formation. The cross-sectional show formation mode is the method for automatically changing channels on the basis of predetermined programs. Examples of the selection guide picture format are shown in FIGS. 6A and 6D, and examples of the automatic CH-charge conversion list in FIGS. 6B, 6C, 6E and 6F. When a picture format of this cross-sectional show formation is selected, the channel numbers is transmitted to the data center 1 and TV receiver 6 each time the channel-change time described in a selected program list comes. Reference numeral 34 denotes an example of the service of which the viewing time-unit rate is not changed throughout the program, and 35 an example of the guide picture format associated with the service of which the time-unit rate changes each time the content changes. Reference numerals 24a and 24b respectively represent the content-by-content format and item-by-item format of the automatic CH-charge conversion list associated with the picture format 34. Reference numerals 25a and 25b respectively indicate the content-by-content format and item-by-item format of the automatic CH-charge conversion list associated with the picture format 35. FIGS. 7A and 7B show examples of the selection guide picture format and show-table/charging list (additional data) in the customized show formation model. The customized show formation model is the method in which the viewer himself or herself downloads a show table with content viewing fee added as indicated by 36 and generates a program list as indicated by picture 35. The program is executed in the same way as in the cross-sectional show formation. Shown at 26 is an example of the show-table/charging list that corresponds to the picture format 36. The selection guide picture 36 is produced according to this list, and displayed on the screen of the radio terminal with remote control function. It can be considered that the list-representation selection guide picture data of the cross-sectional show formation mode, the customized show formation mode and the real-time show formation mode as shown at 34-36, 31b, 32b and 33b are acquired from the data center or previously defined. In an example of the search show formation format, items are displayed according to the key words that the user input for retrieval, and a program list is manually produced on the basis of this search list like the customized show formation. The objects to be searched for can be determined by use of a show-table or a performer list previously provided.

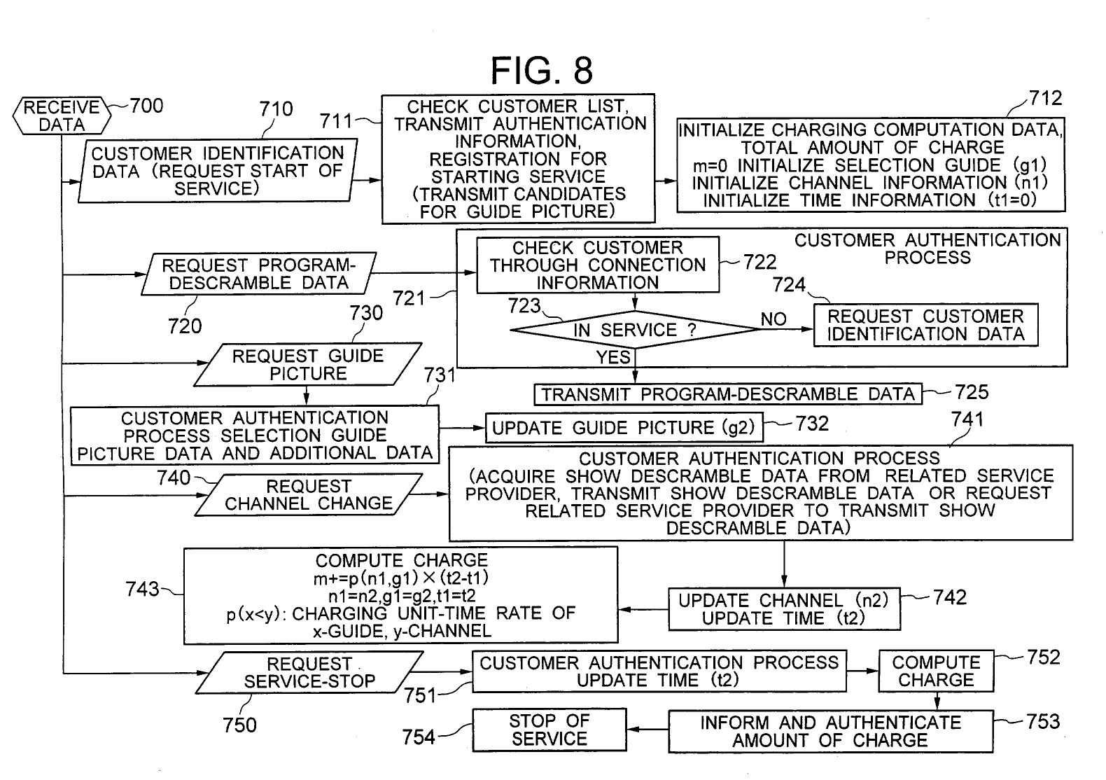

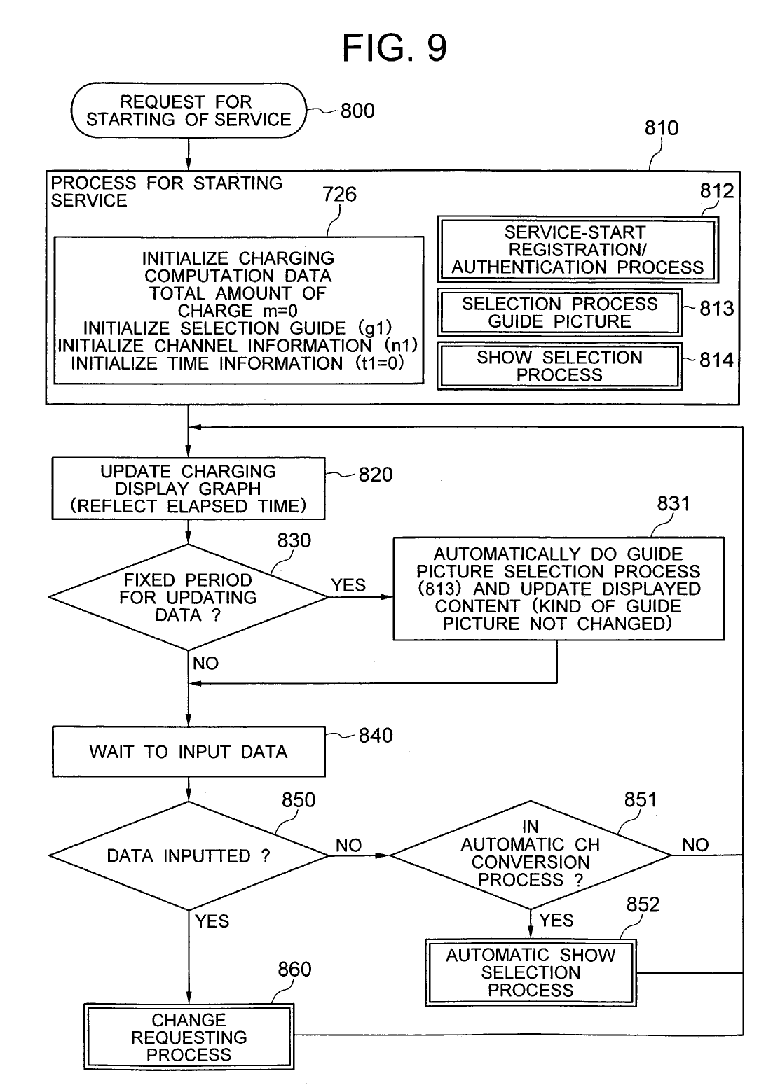

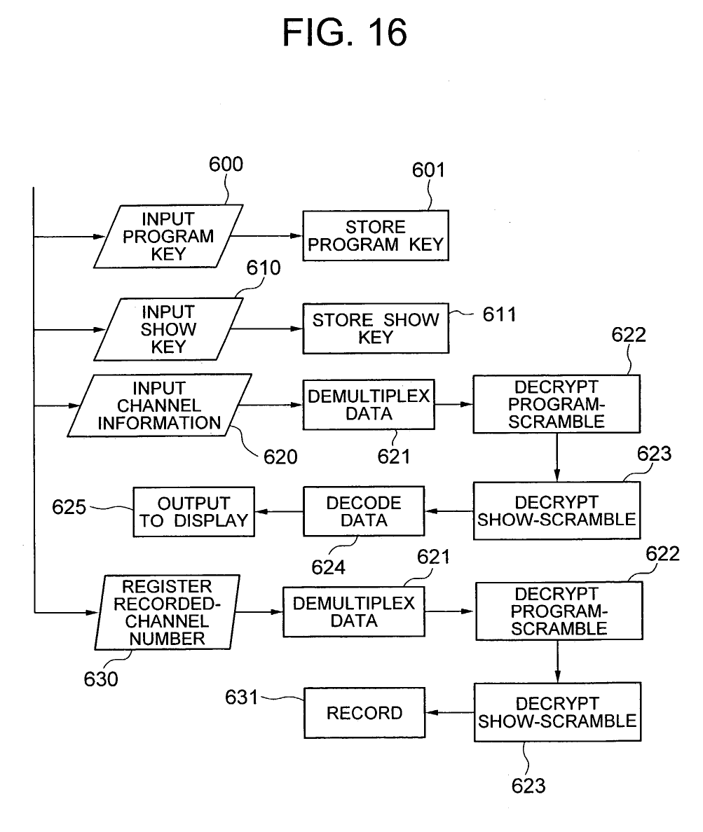

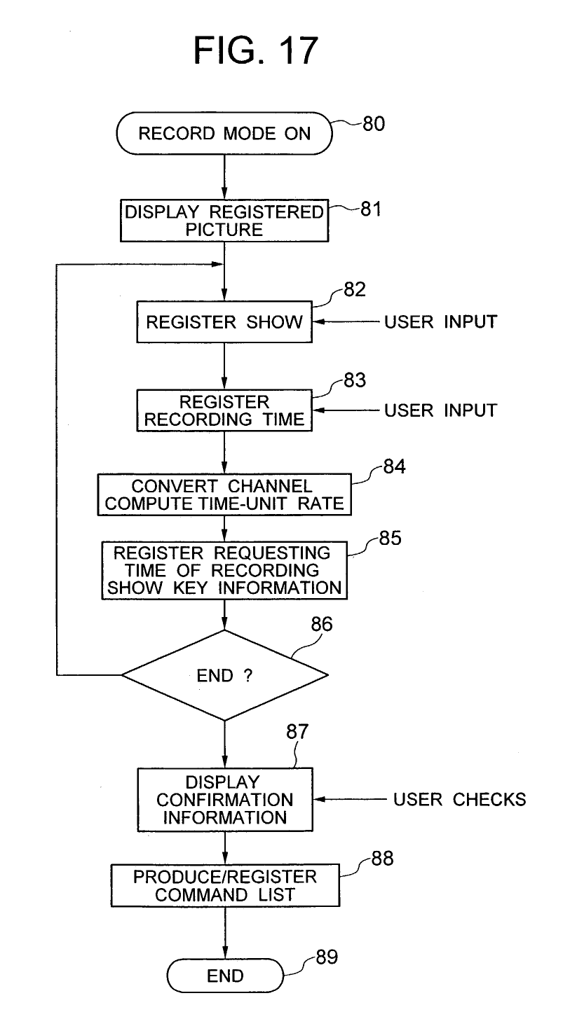

A detailed description will be made of the flow of the program for actualizing the charging service and show selection support service in the multi-camera broadcasting with reference to FIGS. 8-17. FIG. 8 shows the process flow in the data center, FIGS. 9-15 show the process flow in the radio terminal with remote control function, and FIGS. 16 and 17 show the process flow in the TV receiver.

The flow of process in the data center will be mentioned with reference to FIG. 8. The data center executes the processes according to the kinds of received data 700 from the user. The received data includes customer identification data 710, a program-descramble data request 720, a guide-picture request 730, a channel-change request 740 and a service-stop request 750. When the data center has received the customer identification data 710, it checks the customer list, confirms that the customer is already registered, and then transmits authentication information to the requested customer, informing that the service is going to start (711). At the same time, it registers the start of service in the customer's data (711) and informs the multiplex-signal sending broadcast communication service providers with which the customer made an agreement what the measured-rate charging is to be started for this customer. In this case, a candidates list of selection guide pictures may be transmitted to the customer. In addition, the data center initializes the charging computation data for this customer (712). When the data center again receives the customer identification data from the same customer after the initialization of the charging computation data, the data center takes priority of this last received data, and again makes the same processing (generally, the number of times of repetition is specified). The customer identification data may be customer ID, password or telephone number, though not specified in this application specification. If the data center receives a request to transmit the program-descramble data 720 (the details will be mentioned later) that is necessary for the user to receive the viewing support service and charging service in the multi-camera broadcasting, it performs a customer authentication process 722. If the request is confirmed to be sent from the customer who is enjoying the service, the data center transmits program-descramble data (725). The customer authentication process 722 identifies the customer and checks the status using the transmitted information on line (722, 723). If the service is on, the data center transmits program-descramble data (725). If not so, it requests the customer to transmit the customer identification data that is necessary for the service start procedure shown in process 711 and 712 (724). If the data center has received a guide picture request 730, it makes customer authentication process (to confirm that the requester is the customer, and set the object to be changed in the service situation), and transmits selection guide picture data and additional data corresponding to the requested guide picture format. At this time, the kind of the attached additional data depends on the format of the selection guide picture. That is, the automatic CH-charge conversion list is sent when the format is the cross-sectional show formation, the show table/charging list is sent when it is the customized show formation, the show-charge corresponding list is sent when it is the real-time selection, and the search site information or search list is sent when it is the search show formation (731). In this case, either both data may be transmitted through a radio network, or the additional data and the selection guide picture data may be separately sent through the radio network and a broadcasting network, respectively. At the same time, the data center updates the selection guide registration of charging computation data for this customer (732). When the data center has received a channel change request 740, it first makes customer authentication process, and then transmits show-descramble data (the details will be mentioned later) that is necessary for the viewer to view the show of the channel newly selected (741). At this time, when the latest show-descramble data is held in the service provider that edited those show broadcast materials and televise them, the data center acquires this latest show-descramble data or requests this service provider to distribute the show-descramble data for the customer. Then, the data center updates the channel number and time of the charging computation data for this customer (742), and continuously updates the total amount of current charge (743). When the data center has received a service stop request 750, it first makes customer authentication process and updates time (751). Then, it computes the total amount of charge from the start of service to the end of service (752). The data center informs the customer of the total amount of viewing fee, and waits for the customer to send acknowledgement (753). As soon as the acknowledgement data is sent to the data center, the data center changes the service status of the customer to service stop within the customer list. The authentication procedure of process 753 can have some patterns. For example, when the service ends, both notifying of the total amount of charge and the authentication process may be made at the same time, or only the total amount of charge may be informed of, but the authentication process may be made at the time of the next use of service or performed by e-mail with cryptograph or password. The authentication process may be made by letting the viewer confirm on the screen of the radio terminal, or by causing the data processor of the radio terminal to compare with the calculated result within the terminal, in which case if there is no problem this confirmation is automatically sent, while if there is a problem the detailed confirmation process (checking of selected channel log) is performed so that matching can be taken between the radio terminal and the data center. In addition, in order to offer the measured-rate charge service according to this application, the data center needs to play such an intermediation role as to distribute the amount of charge to a plurality of broadcast communication service providers or content providers that participate in the multi-camera broadcasting.

Here, the roles of the program scramble and show scramble will be described. The program scramble is used to restrict the use of the whole service, and the show scramble is used to restrict the use of broadcast data of each channel. Specifically, the use of the measured-rate charging service is restricted by the program scramble, and the use of each broadcast channel is restricted by the show scramble. Proper utilization of these two types of scramble will make it possible to offer the service according to the conditions of an agreement that the viewer made. This stepwise scrambling method is first necessary particularly when the maintenance company that performs the measured-rate charging service is different from the broadcast communication service provider that transmits multiplex signals. This stepwise scrambling method plays a role to define the services of area in the two organizations, and makes it clear which one of the broadcast content distribution service and charging/selection support service the viewer should pay for. In order that the maintenance company for the measured-rate charging service does not infringe the right of the broadcast communication service providers, the maintenance company for the measured-rate charging service should not treat the show scramble data. In this stepwise scrambling method, a process 741 in FIG. 8 can be performed if the maintenance company for the measured-rate charging service requests the broadcast communication service providers to distribute show-descramble data to the customer. Similarly, the formats and schemes of the selection guide pictures may include know-how of the maintenance company for the measured-rate charging service. Therefore, the broadcast communication service providers that do not directly utilize its license should not touch the technical details for the generation of selection guide picture format. Secondly, when there are a plurality of service providers that edit show materials or there are a plurality of service providers that broadcast multiplex signals, the broadcast service providers that employ different scrambling methods are not required to change and standardize those scramble methods. Under this stepwise scrambling method, the multi-camera broadcasting can be performed even if the service providers that build the show scramble in communication apparatus and the service providers that use telephone network or Internet for decrypting the show-scramble participate in the multi-camera broadcasting at the same time, or even if the service providers that employ different scramble systems participate in the multi-camera broadcasting at the same time. Moreover, since it is not necessary to negotiate the show scrambling methods with a plurality of the broadcasting service providers, the installation is also easy. Thirdly, even if a non-contract broadcaster is participated in the multi-camera broadcasting, it can offer its service to the viewer. Since the show scramble of the stepwise scrambling method restricts the use of the show service, the program scramble may accept or reject only the use of the whole service. Fourth, this stepwise scrambling method makes it possible to meet the request for the viewer to view the show of each channel as a normal broadcast without use of the show selection support service and measured-rate charge service in the multi-camera broadcasting. This request can support by applying the mechanism, in which the viewer can watch the show that is encrypted by a show-scramble without the program-scramble, to the service.

Some patterns can be considered to apply the program scramble. Two typical methods will be described here. First, a method can be considered in which the program scramble is applied to the selection guide picture data. If this program scramble is used to protect the selection guide pictures from unauthorized use, even this method can be effectively used for that purpose, or it is effective to restrict the use of only the show selection support service and measured-rate charging service. In addition, it is also effective for the selection guide picture data to be provided not through a radio network but by a broadcasting medium such as data broadcasting, so that the amount of data communication through radio network can be expected to reduce. Secondly, the program scramble may be incorporated in the broadcast contents. When the maintenance company that offers the measured-rate charging service is different from the broadcast communication service providers that distribute multiplex signals, the maintenance company that offers the measured-rate charging service requests the broadcast communication service providers to apply the program scramble. Specifically, two methods can be considered; the program scramble is applied to all camera signals or in only some camera signals. The method in which the program scramble is applied to all camera signals is effective when the viewing right approval of the maintenance company that offers the measured-rate charging service is the minimum requirement for the viewer to use the service of multi-camera broadcasting. Particularly when the maintenance company that offers the measured-rate charging service is completely entrusted with the charging process so that the measured-rate charging service is the only charging computation method, the use of the method in which the program scramble is applied to all camera signals can be considered preferable. The method in which the program scramble is applied to some camera signals will be effective when the time-unit rates in case that a content can view at basic-fee or is free of charge and has no show-scramble are different from that of the measured-rate charging service. If the program scramble is applied to only the contents which can view at the basic charge and are free of charge and have no show-scramble, the service providers which offer the measured-rate charging service can be paid for these contents. In the method in which the program scramble is applied to only some camera signals, it can be considered that on the contrary the program scramble is not applied to the contents which can view at the basic charge and are free of charge and have no show-scramble. The stepwise scramble according to this application can be said to be satisfactory to various practice environments. In addition, the second embodiment of the method in which the program scramble is applied to the broadcast contents can be considered to be effective to offer various services even when the maintenance company that offers the measured-rate charging service and the broadcast communication service provider that distributes multiple signals are managed by the same owner. If there are shows to which only content unit charging is permissible, the show scramble may be applied to the content, and the program scramble to the measured-rate charging content. In addition, since use of show scramble can prevent a plurality of contents from being viewed at the same time, the application of show scramble to each of contents and program scramble to the whole can increase the security of each of the materials.

The procedure to descramble a single content in which both program scramble and show scramble are applied will be described. Two cases can be considered for descrambling; two descramble data can decrypt the two scrambles applied to the content, respectively, and single descramble data can decrypt the two scrambles applied to the content. In the former case, if there are not both program descramble data and show descramble data, the content cannot be viewed. In this case, the program-descramble data is transmitted to the viewer from the maintenance company that offers measured-rate charging service, and the show-descramble data to the viewer from the broadcast communication service provider that distributes multiplex signals. Therefore, in order to switch from the measured-rate charging service to the normal charging service, it is first necessary to shift the charging management right from the maintenance company to the broadcast communication service provider and to stop the selection support service to the viewer. Then, the program-descramble data is transmitted to the viewer (the viewer is given the right of acquiring the program-descramble data by the radio terminal with remote control function). In this former case, even when the broadcast communication service provider applies the program scramble, it is violation of an agreement that the broadcast communication service provider transmits the program-descramble data. In the latter case, the maintenance company that offers the measured-rate charging service and the broadcast communication service provider that distributes multiplex signals must be fundamentally the same company. If service switching is made from the measured-rate charging service to the normal charging service, the show descramble data including a program descrambling function is transmitted instead of the show scramble data. It is also possible to transmit the program-descramble data including the show descrambling function in order to avoid both show-descramble data and program-descramble data from being supplied. Moreover, it is possible to properly use the program-descramble data or the program-descramble data including the show descrambling function according to the conditions of an agreement that the customer made. In the latter case, when different companies make the maintenance of measured-rate charging service and distribution of multiplex signals, respectively, the broadcast communication service provider that distributes multiplex signals may request the measured-rate charging service maintenance company to transmit the program-descramble data including the show-descrambling function. Particularly when there are a plurality of broadcast communication service providers that distribute multiplex signals for the multi-camera broadcasting, it will be effective to use the methods for properly utilizing the program-descramble data or the program-descramble data including the show-descrambling function according to the presence or absence of the request to act for scramble distribution.

This specification does not limit the specific method of scrambling. However, different scrambling processes can be applied to different locations of a digital video signal, and thus both program scramble and show scramble can be used at a time. In other words, only a single scramble can be decrypted in case that both the program scramble and the show scramble are applied. In addition, since the descramble data may be encrypted, the show-descramble data could be encrypted, and it could be decrypted by the program-descramble data.

The flow of the processes in the radio terminal with remote control function will be described with reference to FIGS. 9-15. The whole process will be first mentioned with reference to FIG. 9. When the radio terminal receives a service request 800 from the user, it makes a service start process 810. In the service start process 810, the radio terminal first initializes (726) charging computation data and makes a service-start registration/authentication process 812 (the details will be mentioned later), thus the radio terminal and the data center confirming the start of service. Secondly, the candidates list of selection guide pictures are displayed, and a guide picture selection process 813 (the details will be mentioned later) is performed. The candidates of selection guide pictures may be previously specified and registered on the radio terminal or the candidates list those pictures may be transmitted from the data center. Thirdly, in the case of real-time show selection is selected by user, a show selection process 814 (the details will be mentioned later) is executed according to the selection guide pictures received and displayed. When the selected guide picture is not the real-time show selection format, the guide picture selection process 813 automatically generates a channel-changing list, thus the show selection process being omitted. After the end of the service start process 810, a routine work of process 820-process 860 is performed. When the radio terminal knows the data input from the user in process 840, 850, the radio terminal executed a change requesting process 860 (the details will be mentioned later), and the process flow goes back to the process 820. However, when the request is to stop service, the total amount of charging is computed, and then the service is stopped at process 860. If data input from the user is not received even after the input waiting time at process 840 expires, it is checked to see if the automatic CH conversion program is active, or if the current selection guide picture is of the cross-sectional show format, customized show format or search show format (851). If the automatic CH conversion program is active, an automatic show selection process 852 (the details will be mentioned later) is carried out. When the automatic CH conversion program is not active, the the process flow goes back to the process 820. In the process 820, data for representation of picture of charging display graph 37 is updated (process 820) as time goes on. A process 830 decides if it is now time to update selection guide picture data. The shorter update interval will lead to the more accurate support, but the fee of access to the data center increases (the selection guide picture data may be distributed from the broadcaster). Therefore, it is appropriate that each user should set the update interval. If the selection guide picture data is decided to update in process 830, the format of the current guide picture is automatically changed by reselection in process 831 so that the guide picture selection process 813 is made, thus updating the guide picture displaying. After updating, the process flow goes to a process 840. If it is decided not to update the selection guide picture data in process 830, the process flow goes to process 840.

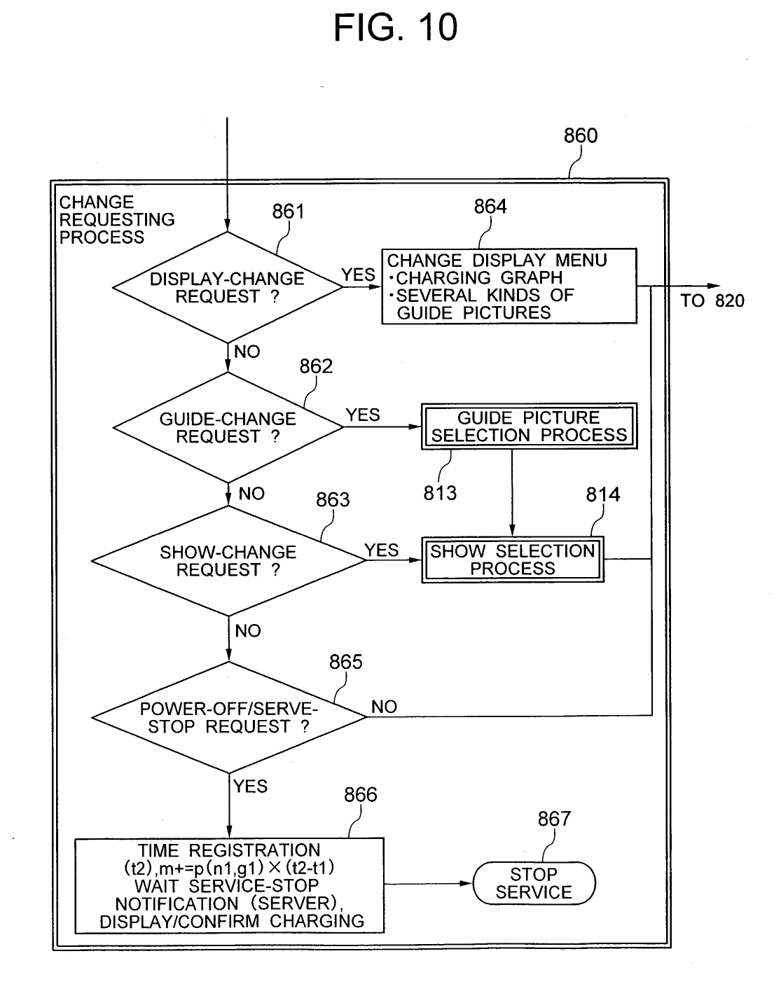

The change requesting process 860 will be described in detail with reference to FIG. 10. The user can request as a display-change request, a guide-change request, a show-change request and a power-off/service-stop request. If the user inputs the display-change request (861), the display mode is charged according to a request (864), and then the process flow goes back to process 820. Since the display modes are shown with reference to FIGS. 5-7, they will not be described here, but includes visual representation, list representation and charging graph representation. The real-time viewing fee can also be displayed by computing the present total amount of fee from the amount of viewing fee up to the time when the current channel is selected, channel change time, present time and time-unit charging rate of viewed channel. The total viewing fee can be computed by adding amounts of fee obtained at each time of updating the time-unit charging rate of channel at every constant time or by use of the equation of (total viewing fee to be charged up to the time when the current channel is selected)+(time-unit rate of current viewing channel)x(current time-time when the current channel is selected). When the user inputs a selection guide-change request 862, the guide picture selection process 813 (the details will be mentioned later) is executed, and then the user is requested to make the first show selection (814) (the details will be mentioned later). If the user inputs a show-change request 863, the show selection process 814 is executed (the details will be mentioned later), and the process flow goes back to process 820. If the user inputs a power-off/service-stop request 865 (which includes the case where the power of TV receiver is disconnected), processes 866 and 867 are executed and then service is stopped. If the user inputs other request than the above, the process flow goes back to process 820. In process 866, the total amount of charging from the start of service to the stop of service is calculated, and the service-stop confirmation process is done. After the end of process 866, the service is stopped (867). Some patterns can be considered in the charging fee confirmation/authentication procedure as explained with reference to process 753 of FIG. 8. For example, in one pattern, at the end of service the amount of charging and authentication process are notified of and made between the radio terminal and data center. In another pattern, the data center only informs the radio terminal of the amount of charging at the end of service, and the radio terminal makes the authentication process at the next use of service or makes it by use of e-mail written in cipher or with password. The authentication process may be performed by the viewer's confirmation on the screen of the radio terminal or by use of data processor of radio terminal to compare with the calculated results within the terminal, in which case if there is no problem, the replay is automatically sent, or if there is a problem, it confirms in detail (checks the selected channel log) so that matching can be obtained between the radio terminal and the data center.

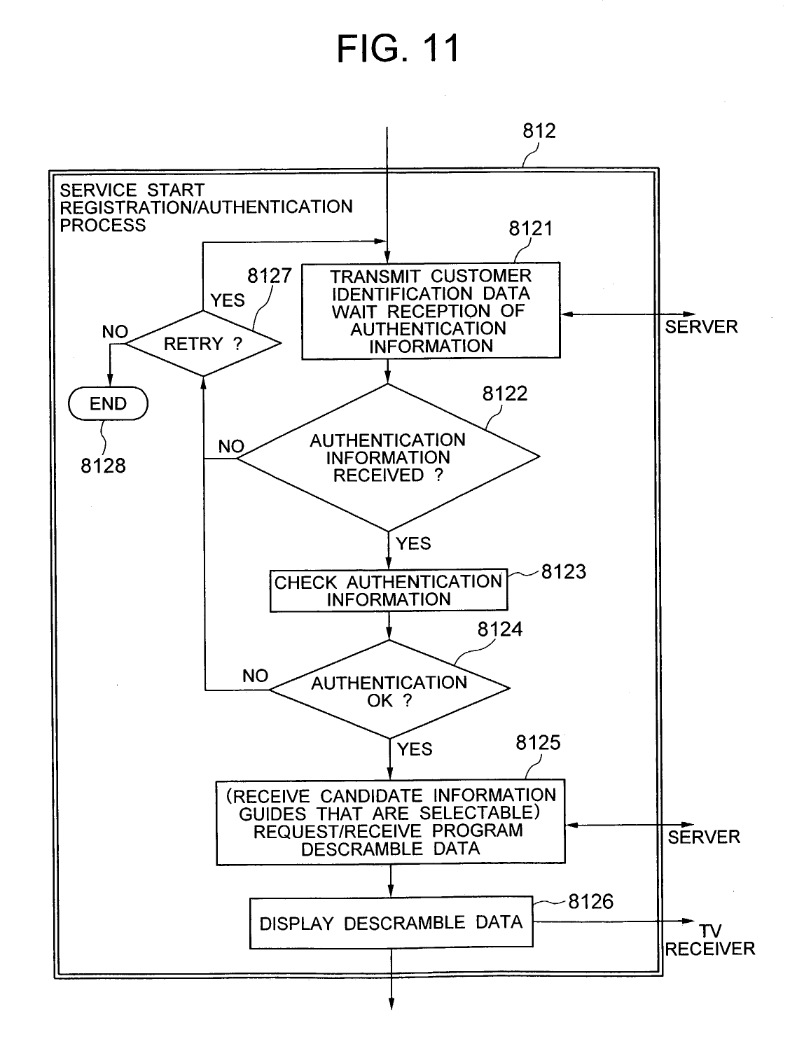

The service-start/authentication process 812 will be described in detail with reference to FIG. 11. When the user inputs a service-start request, the radio terminal transmits customer identification data to the data center (8121). The radio terminal, after that waits for the data center to answer authentication information (8121, 8122). The detail of the customer identification data, though not designated in this specification, may be customer ID, password or telephone number. If the radio terminal does not receive the authentication information from the data center even after a constant time has elapsed, it checks to see if retransmission of the customer identification data is established (8127). If so, the process flow goes back to process 8121. If not so, the service-start request is canceled out (8128). If the reception of authentication information from the data center is confirmed (8123), the radio terminal confirms if the authentication information has a problem (8124). If the mismatching to the transmitted customer identification as a received authentication information is found, it checks to see if the retransmission of customer identification data is established (8127). If so, the process flow goes back to process 8121. If not so, the service-start request is canceled out (8128). If the radio terminal has confirmed that the transmitted customer identification data matches with the received authentication information in the process 8124, the process flow goes to process 8125. In process 8125, when the radio terminal has received the candidate information of guides that are selectable at the authentication process time, it displays the candidates list on its screen. Then, it requests to transmit program descramble data, and receives that data. When the program scramble is applied to the TV signal, this descramble data is provided to the TV receiver.

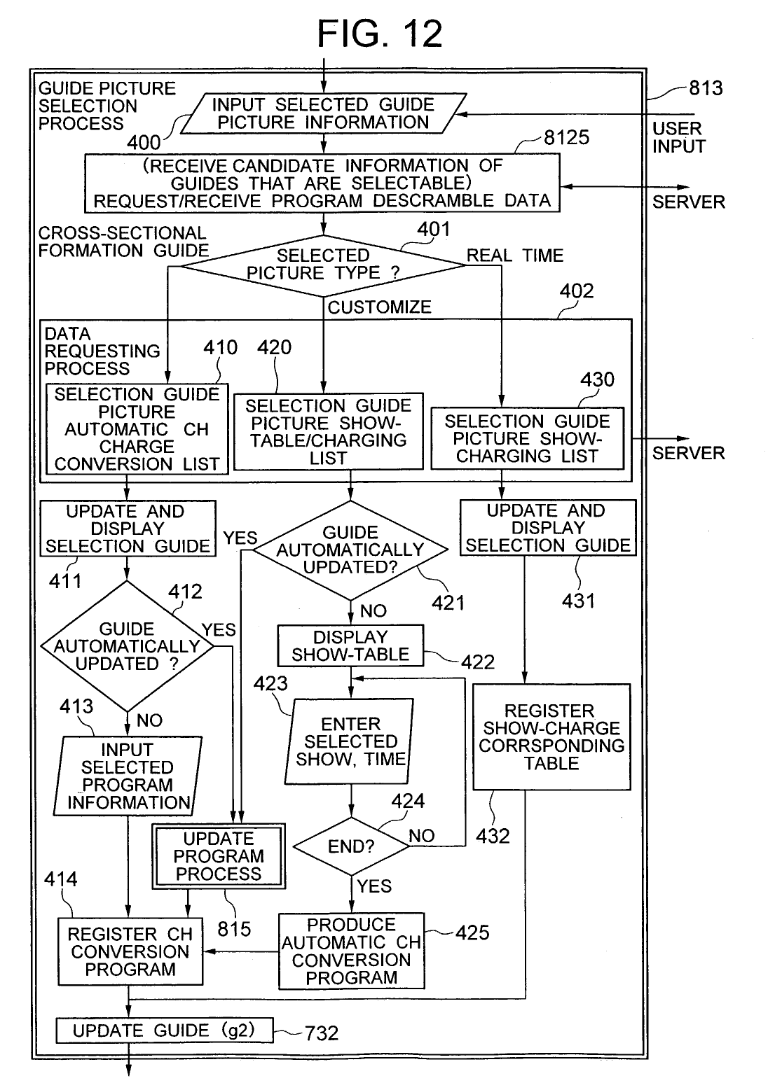

The guide picture selection process 813 will be described in detail with reference to FIG. 12. The radio terminal can receive selected guide picture type information 400 by user's input operation or by its automatic selection at the time of selection guide update. In the former case, the radio terminal first performs process 8125, thus selecting the guide picture to be used and acquiring program descramble data. In the later case, the process 8125 is fundamentally omitted. When the selected guide picture cannot be used, however, the user may be requested to make reselection operation. Moreover, if the methods for regularly updating the program scramble is incorporated in service, the radio terminal may request to provide the latest program descramble data for updating.

Then, the radio terminal performs a branch process according to the kind of selection guide (401). The branch process begins with a data request process 402 for acquiring the selection guide picture and additional data from the data center. If the kind of selection guide picture is cross-sectional show formation format, the radio terminal first acquires the selection guide picture and automatic CH-charge conversion list (410), and if necessary (when the list is changed), the displayed picture is updated (411). When the user inputs data in process 400, the screen is changed to a selected program information input mode for generating the program list, and the terminal waits for the user to input data (413). When the program list is completed from the user, that information is registered in the CH conversion program of the radio terminal (414). When the input data is automatically updated regularly in process 400, the radio terminal executes update program process 815 (which will be described later), and then registers the updated program list in the CH conversion program (414). After the execution of process 414, the radio terminal updates the selection guide registration of charging computation data (732). When the kind of the selection guide is the customized show formation format, the radio terminal first acquires the selection guide picture and show-table/charging list (420). If the user inputs data in process 400, the radio terminal executes the update program process 815 (which will be described later). When the input data is automatically updated regularly in process 400, a show table is displayed (422), and the program list is customized by the user (423, 424). As a result, the automatic CH conversion program is generated (425). Then, the radio terminal registers the updated or produced program list in the CH conversion program (414), and updates the selection guide registration of charging computation data (732). When the kind of selection guide is the real-time selection format, the radio terminal first acquires the selection guide picture and show-charge corresponding list (410). Then, the radio terminal updates and displays the selection guide picture (431), and registers data of show-charge corresponding list (432) and the selection guide of charging computation data (732). When the kind of selection guide is the search show formation, though not shown in detail in the figure, the radio terminal acquires the search guide picture and search site information or search list, and generates the automatic CH conversion program by the same procedure as in the customized show formation.

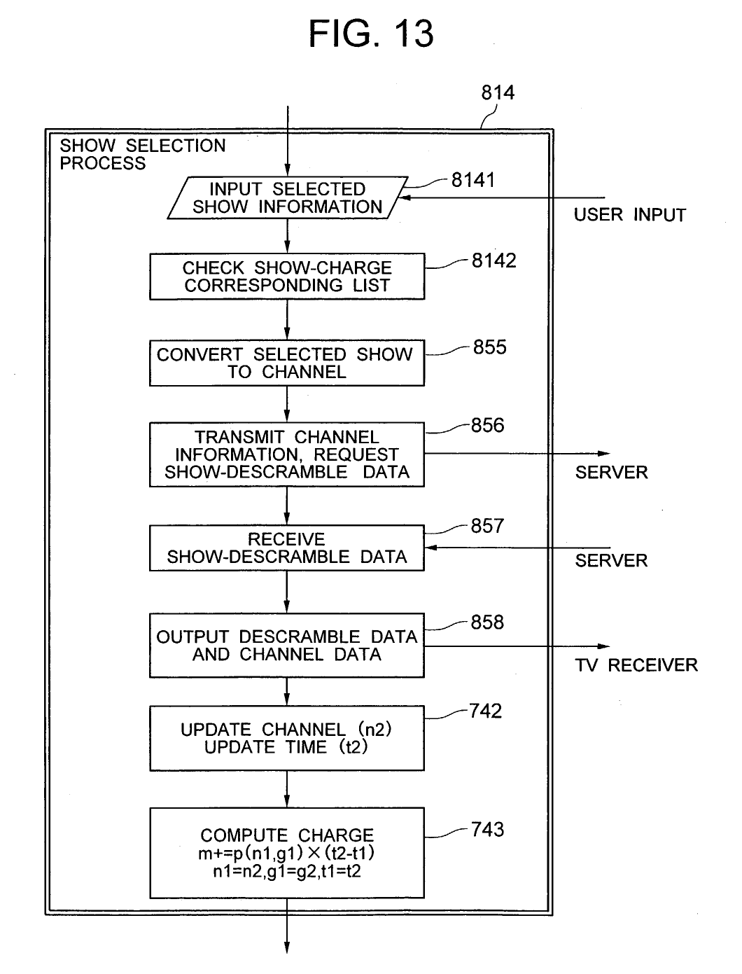

The show selection process 814 will be described in detail with reference to FIG. 13. This process is performed when the kind of selection guide is the real-time show selection. When the user selects a show on the selection guide picture, the selected show information is inputted in the ratio terminal (8141). The radio terminal checks the show-charge corresponding list and selected show information (8142), and converts the selected show into a channel number (855). The selected channel information is transmitted to the data center (856). At this time, when show descramble data is necessary for the viewer to view the selected channel, the radio terminal requests the data center or broadcast communication service provider to transmit show descramble data (856), and receives the descramble data (857). The data center provides the show descramble data through a radio communication network or the service provider that distributes the contents corresponding to the selected channel is requested to transmit the show descramble data. The show scramble data which is provided by the broadcast communication service provider is transmitted by operating communication apparatus (terminal or set-top box) that the user owns or by way of telephone network or Internet. The show descramble data and channel number thus acquired are supplied to the TV receiver (858). The radio terminal finally updates the channel information and time information of the charging computation data (742), and the present total amount of charging (743).

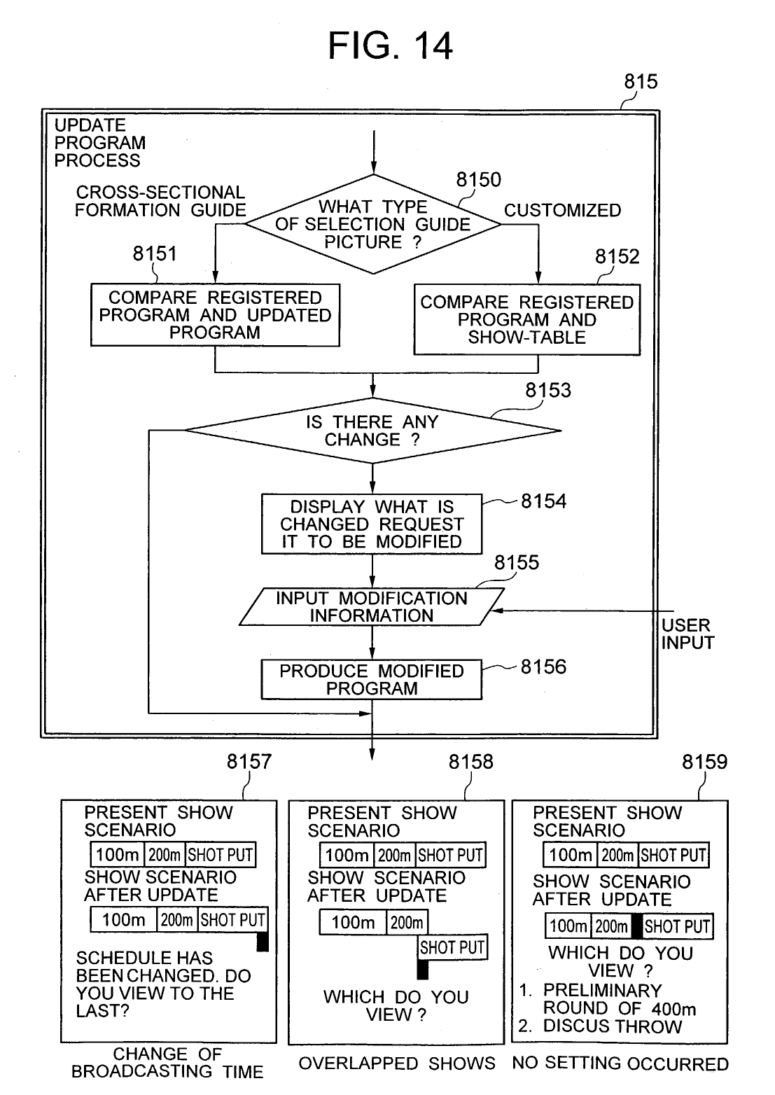

The update program process 815 will be mentioned in detail with reference to FIG. 14. This update program process 815 is performed when the selection guide picture for the automatic CH conversion program process is regularly updated. The radio terminal first checks the kind of the current selection guide picture (8150). If the guide picture is the cross-sectional show formation, it compares the registrated program and updated program (8151). If the guide picture is the customized guide formation or search guide formation, it compares the registrated program and the show-table (8152). If it is decided from the compared result that the desired show cannot be viewed under the registered program due to the change of show broadcast schedule (8153), the registered program is modified. First, the modification pattern is displayed (8154) on the screen of the radio terminal as shown in the pictures 8157-8159 (since there is a possibility that the user does not perceive it on the screen, it is effective to make a sound with the picture). The picture 8157 shows an example of extended broadcasting time, the picture 8158 shows an example of overlapped shows, and the picture 8159 is an example of no setting time occurred. Then, the radio terminal generates modified program (8156) according to the modifying information from the user (8155).

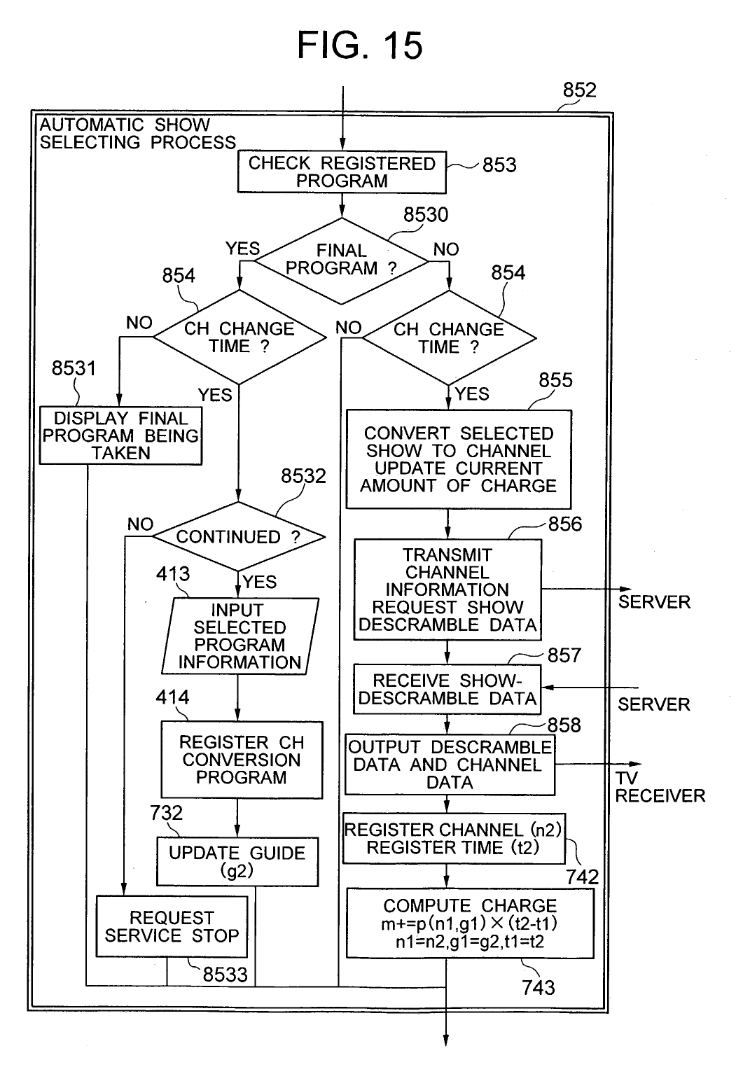

The automatic show selection process 852 will be described in detail with reference to FIG. 15. This automatic show selection process 852 is carried out when the selection guide picture for the automatic CH conversion program process is selected. The radio terminal first checks the registered automatic CH conversion program (853), and examines if the currently viewing show is the final show (8530) or has reached the CH-change time (854) of the registered program. If the currently viewing show is not the final show of the registered program, but CH-change time, the radio terminal executes the process 855-process 743 as shown in FIG. 15 (these processes were explained with reference to FIG. 13, and thus will not be described here). If the currently viewing show is neither the CH-change time nor the final show of the registered program, the radio terminal makes no action (8530,854). If the currently viewing show is not the CH-change time but the final show of the registered program, the radio terminal displays (it can make a sound, too) on the screen that the currently viewing show is the final show of the registered program (8531). If the currently viewing show is the final show and CH-change time of the registered program, the radio terminal first checks to see if the user wants to continue or to stop viewing (8532). At this time, when the user requests to stop viewing, the radio terminal transmits the service-stop request to its control unit (8533). If the user requests to continue to view, the radio terminal switches the current display mode into a selected program information input picture mode for the later program list generation, requesting the user to input (413). When the user completes a program list, the radio terminal registers that information in the CH conversion program (414), and updates the selection guide registration of charging computation data (732).

With reference to FIG. 16, a description will be made of the flow of channel change and descramble process in the TV receiver to which the descramble data has been supplied from the radio terminal. The data that the TV receiver receive from the radio terminal has a program key for decrypting the program scramble, a show key for decrypting the show scramble, and the channel number. When the TV receiver receives the program key or show key (600, 610), it is stored it (601, 611). When the TV receiver receives the channel number (620), it makes channel-switching process. Specifically, first the TV receiver obtains the contents to be viewed by de-multiplexing the multiplex signal data received from the broadcasting station (621). Then, the TV receiver decrypts the program scramble and show scramble by use of the stored key data (622, 623). However, as shown in FIG. 8, the way of applying two kinds of scrambles is dependent on the contents. In addition, since the decrypting procedure and method depends on the content service providers in case of show scramble, both or either one of these processes 622, 623 is sometimes omitted. The content data which has been already decrypted is decoded (624) and displayed on the screen (625). The process path from process 630 to process 631 shows the flow of processes for recording a plurality of contents simultaneously broadcast. When those contents are recorded at the same time, the amount of charging depends on the number of contents to be recorded. Also, in order to view the recorded shows, it is necessary to previously receive plural number of descramble data corresponding to content number. The process path from process 630 to process 631 shows the crypting procedure for use in recording a plurality of contents. In process 630, TV receiver first records the numbers of a plurality of channels to be recorded. In process 621, the TV receiver de-multiplexes show data to be recorded from the multiplex signal data. Since descramble key data for each show are stored by the process 611, the process 622 and process 623 descramble the show and makes it be recorded on its recorder (631).

With reference to FIG. 17, a description will be made of an example of the method for producing a command list that enables the recorder to record a plurality of multi-camera video images. When the user requests the radio terminal to call a reservation function for simultaneous recording of a plurality of channel video signals (80), it displays a recording registrated picture (81). Then, when the user inputs simultaneously-recording shows and recording start/end times (82, 83), the radio terminal converts the shows into channel numbers, and computes the time-unit rate in the recording processing time (84). The time-unit rate of the contents to be recorded can be computed by simply adding the time-unit rate of each content with respect to time axis or by providing discount rates according to the number of selected shows. Then, the radio terminal registers the requesting time of the recording show key for decrypting of show-scramble depending on the user requests. The processes 82-85 are repeated until the user input registration end (86). When the user checks to see if the registration is completed from the confirmation picture of registered shows (87), the radio terminal produces a command list for executing the recording process (88). The command list includes start time of list, number of recorded contents, a time-unit rate variation graph of recorded contents or time-unit rate of each recorded content, channel number of each recorded content, recording time and show key requesting time. Commands are automatically executed as time goes on.

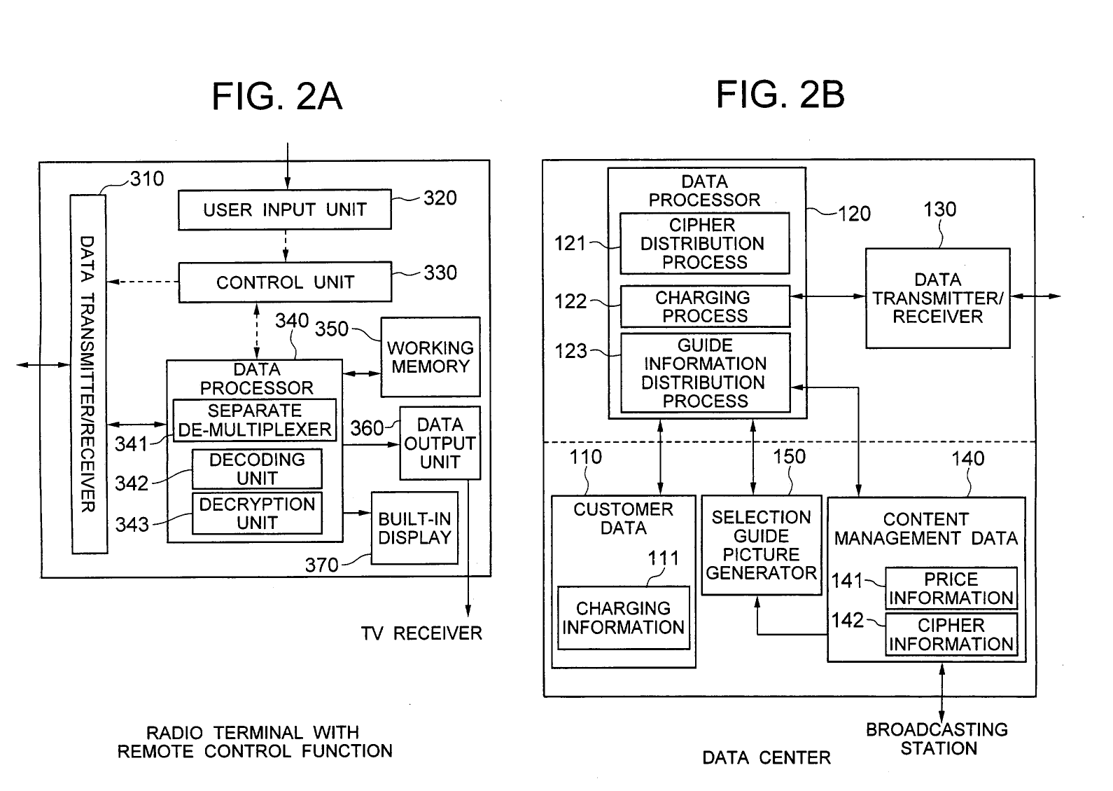

FIG. 2 shows basic structures of the data processors of the radio terminal with remote control function 8 and data center 1 shown in FIG. 1. As shown in FIG. 2 at (a), the radio terminal with remote control function has four interfaces of a data transmitter/receiver 310, a user input unit 320, a data output unit 360 and a built-in display 370. The data transmitter/receiver 310 is connected to a radio communication network, and executes data communication process on the basis of the command from a control 330. The user input unit 320 passes the user input from a key controller to the control 330. The data output unit 360 is used to supply data output to external apparatus. The control 330 serves to control the whole data processing on the basis of the request from the user. A data processor 340 is responsive to the order from the control 330 to process the input data from the data transmitter/receiver and generate the output data. The data processor 340 has programs and operation units for executing a data de-multiplex process 341 that analyzes the input data and de-multiplexes it into available units, a decoding process 342 that decodes the input binary data into meaningful data, and a descramble process 343 that decrypts scrambled data. A working memory 350 serves to store the data that is being processed in the data processor, and pending data that is not processed or transmitted yet. The data center, as shown in FIG. 2 at (b), has a server 110 for managing customer data, and a server 140 for managing content management data. The customer data server 110 is accessed to at the time of authentication of customer and registration of charging data 111. The content management data server 140 transmits and receives data to and from the broadcasting stations to manage/update price information 141 of broadcast contents and cipher information 142 for descrambling each broadcast channel. A selection guide picture generator 150 produces selection guide picture data and additional data for supporting user's selection of show on the basis of the latest information held within the content management data server. The data processor 120 is connected to the customer data server 110, content management data server 140 and selection guide picture generator 150, and offers service to the radio terminal with remote control function 8 in response to the request from the customer. The data processor 120 has programs and operation units of a cipher distribution process 121 that selectively distributes scrambled data of each selected channel, a charging process 122 such as the graph 7, a guide information distribution process 123 that distributes selection guide picture data and additional data, and a customer authentication process. The data transmitter/receiver 130 serves to transmit and receive data to and from the customers.

The present invention includes the following scope.

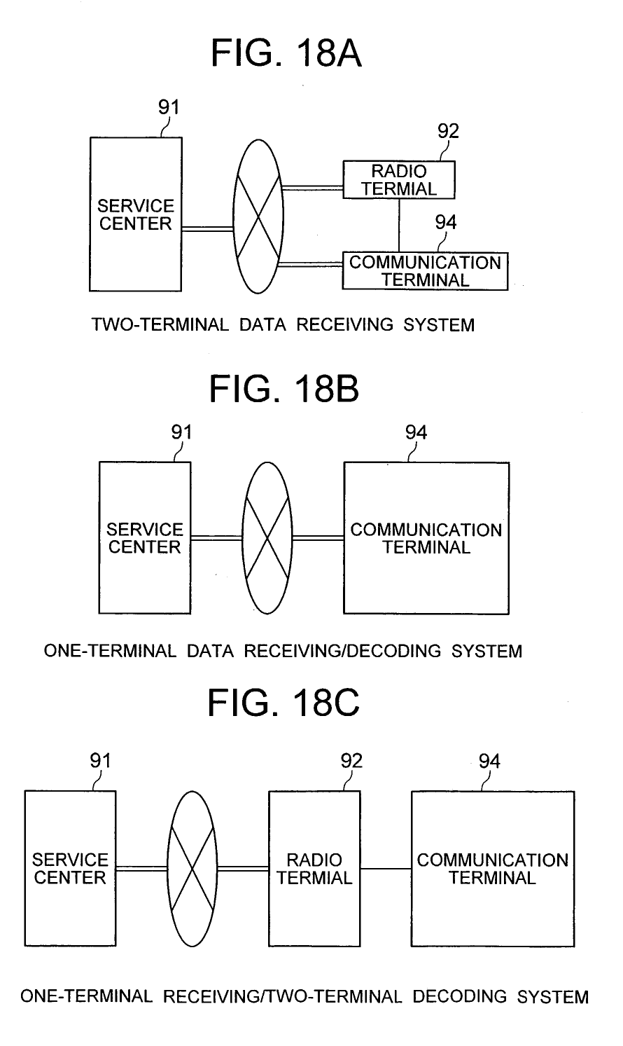

(1) We have so far explained means for enjoying the measured-rate charging service and selection support service of multimedia broadcasting by use of the radio terminal connected to a radio communication network and the TV receiver that receives broadcast data as shown in FIG. 1. However, only the broadcasting service providers are not the communication media that can offer video contents produced from a plurality of cameras. For example, the streaming service using the Internet can also offer the video contents. In this case, as shown in FIG. 18A, a radio terminal 92 and a communication terminal 94 can be connected to a network, and those terminals are connected together by home LAN or cable. While two terminals are fundamentally used as in FIG. 1, only a single receiver terminal or TV receiver that has the functions of the two terminals as shown in FIG. 18B can also enjoy the services that the present application presents. If, for example, a monitor has a function to display video signals on sub-screens or on divided screens, the selected multi-camera signals and selection guide pictures can be displayed thereon at a time. Also, by use of a TV receiver or a set-top box having a network connection function, it is possible to assure two communication paths. In addition, if we provide, as shown in FIG. 18C, the first terminal 92 that has charge of transmitting and receiving data, and the second terminal 94 that is connected to the first terminal 92 by home LAN or cable, the two terminals having monitors can display the selected multi-camera signals and selection guide pictures. For example, the radio terminal 92 that has a function to receive the multi-camera broadcast signals or has a function to connect to the Internet by radio LAN de-multiplexes multiplex signals while descrambling, and supplies the de-multiplexed broadcast contents to the communication terminal 94 having a function to decode the broadcast contents. Also, the selection guide pictures may be transmitted by data broadcasting. Thus, the measuredrate charging service and selection support service of this application can be enjoyed by use of a system that has two display screens, two communication paths and the processing functions given in FIG. 9-FIG. 16, even if the system does not have the construction of FIG. 1. Moreover, the measured-rate charging service and selection support service of this application can be enjoyed by use of a system that has the functions to process shown in FIG. 8, the function to distribute multiplexed multi-camera signals, and the function to generate selection guide picture data even if the system does not have the construction of FIG. 1. The service center 91 shown in FIGS. 18A-18C can be considered as the generic name of the data center and broadcasting station shown in FIG. 1.

(2) Various patterns can be considered about the roles and combination of the data center and broadcasting station as explained with reference to FIG. 1. The scope of application of the present application is defined as the measured-rate charging service and show selection support service including the distribution of descramble data to the viewer or organizations that offer either of the services in the distribution of multi-camera data. Therefore, when these services are offered by a plurality of service providers in cooperation with each other, these service providers include all the organizations having service or business for transfer of charging information, show selection information, and descramble information between such service provider and the viewer. While the charging charge computation process is included in the present application, the present application does not limit the way of collecting the viewing charge (bank transfer, card transfer or the like), and the way to share the viewing charge among the service providers that participate those services. Also, the present application does not limit data format of multiplex signals.

(3) The terms “data center”, “program scramble” and “show scramble” used in this specification are given for convenience sake, and the application scope of this application is not limited by these terms. The roles and functions described in the above embodiments can be included in the scope of this application. The radio terminal with remote control function 8 and TV receiver 6 shown in FIG. 1 are not restricted to their structures, and the communication terminal and video display apparatus having the functions to process as described in the above embodiments are also included in the scope of this application.

Since a measured-rate charging system which computes the charging charge from time-unit rate of contents is applied, the total amount of charging charge does not increase even if channels are frequently changed for camera-angle switching. Thus, the viewer can enjoy pay multi-camera video service with reasonable viewing fee. Since the stepwise scramble scheme is taken in, the multi-camera broadcasting in which different service providers participate also does not need to change the existing security management methods of each provider, but can manage the security of respective contents and the security of the services between the providers. In addition, since the selection support service capable of selecting the show content but not channel is offered, it is possible to produce/select show formations suitable for the viewer's preference, and make camera-angle switching in real time.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A program causing a radio terminal connected through a network to a server and video display apparatus to execute the following processes, said radio terminal having a display unit, an input unit, an output unit and a storage unit, said processes comprising the steps of:
outputting identification information of said radio terminal and a request to start service to said server through said output unit;
acquiring selection guide picture data for urging the user to select any ones of a plurality of shows, and additional data including the content of each of said shows and channel information through said input unit from said server, and storing said data in said storage unit;
constructing a selection guide picture by use of said selection guide picture data and said additional data, and displaying said selection guide picture on said display unit;
when any one of said shows within said displayed selection guide picture is selected through said input unit, converting said selected show into selected channel information, and outputting said selected channel information to said server; and
generating control information for switching to said selected channel when said show is selected, and outputting said control information through said output unit to said video display apparatus.

2. A program causing a radio terminal connected through a network to a server and video display apparatus to execute the following processes, said radio terminal having a display unit, an input unit, an output unit, a storage unit and a channel program executing unit, said processes comprising the steps of:
supplying identification information of said radio terminal and request to start service to said server through said output unit;
acquiring selection guide picture data for urging the user to select any ones of a plurality of shows, and additional data including a plurality of viewing programs having a plurality of shows through said input unit from said server, and storing said data in said storage unit;
constructing a selection guide picture by use of said selection guide picture data and said additional data, and displaying said selection guide picture on said display unit;
when any one of said viewing programs within said displayed selection guide picture is selected through said input unit, registering said selected viewing program in said program executing unit;
outputting channel information corresponding to a show to which switching is made by said executing means at a channel switching time specified in said registered program to said server; and
generating control information for switching to said channel when said switching is made, and outputting said control information through said output unit to said video display apparatus.

3. A program according to claim 1, wherein said additional data also includes viewing time-unit rate information for each of said shows, and said processes further comprising:
counting elapsed time;
storing said channel-switching time and said selected show viewing time-unit rate in said storage unit at said channel switching time; and
computing a viewing charge from said viewing time-unit rate corresponding to said selected show and a channel viewing time converted from said elapsed time.

4. A program according to claim 2, wherein said additional data also includes viewing time-unit rate information for each of said shows, and said processes further comprising:
counting elapsed time;
storing said channel-switching time and said selected show viewing time-unit rate in said storage unit at said channel switching time; and
computing a viewing charge from said viewing time-unit rate corresponding to said selected show and a channel viewing time converted from said elapsed time.

5. A program according to claim 3, further comprising the steps of:
storing said estimated viewing charges in said storage unit;
computing a total viewing charge by adding said converted viewing charges;
storing said total viewing charge in said storage unit; and
displaying the current total viewing charge on said display unit.

6. A program according to claim 4, further comprising the steps of:
storing said estimated viewing charges in said storage unit;
computing a total viewing charge by adding said converted viewing charges;
storing said total viewing charge in said storage unit; and
displaying the current total viewing charge on said display unit.

7. A program according to claim 1, wherein said selection guide picture data is encrypted by a first scramble, said processes further comprising the steps of:
acquiring descramble data for decrypting said first scramble data from said server; and
acquiring from said server descramble data for decrypting a second scramble by which data signal of said selected channel is encrypted,
wherein said step of constructing said selection guide picture and displaying it on said display unit employs said selection guide picture data decrypted by use of said descramble data for decrypting said first scramble, and said step of outputting to said video display apparatus also includes outputting of descramble data for decrypting said second scramble.

8. A program according to claim 2, wherein said selection guide picture data is encrypted by a first scramble, said processes further comprising the steps of:
acquiring descramble data for decrypting said first scramble data from said server; and
acquiring from said server descramble data for decrypting a second scramble by which data signal of said selected channel is encrypted,
wherein said step of constructing said selection guide picture and displaying it on said display unit employs said selection guide picture data decrypted by use of said descramble data for decrypting said first scramble, and said step of outputting to said video display apparatus also includes outputting of descramble data for decrypting said second scramble.

9. A program according to claim 1, further comprising the steps of:
acquiring from said server descramble data for decrypting the first scramble by which said plurality of shows are encrypted; and
acquiring from said server descramble data for decrypting the second scramble by which data signal of selected channel is encrypted,
wherein said step of outputting to said video display apparatus also includes outputting of said first descramble data and said second descramble data.

10. A program according to claim 6, further comprising the steps of:
acquiring from said server descramble data for decrypting the first scramble by which said plurality of shows are encrypted; and
acquiring from said server descramble data for decrypting the second scramble by which data signal of selected channel is encrypted,
wherein said step of outputting to said video display apparatus also includes outputting of said first descramble data and said second descramble data.

11. A server having a network connection unit, a control unit and a storage unit, said storage unit being used to store contents of a plurality of shows, channel information and charging information in association with each other, said control unit being used to control the processes of:
when said control unit receives user identification information and a request to start service from a user through said network connection unit, recording starting of service from said user and starting to count the elapsed time for service offering;
when said control unit receives channel-switching information through said network connection unit, storing said channel switching information and the time of said reception; and
computing a charging charge from said charging information corresponding to the channel viewing time converted from said time and to a selected channel.

12. A server according to claim 11, wherein said control unit controls further processes of:
encrypting information for selection of any one of said plurality of shows by use of a first scramble and outputting said scrambled information to said network; and
when said control unit receives a request to send descramble data for said first scramble through said network connection unit, deciding if said offering of service is possible on the basis of the identification information of said user, and supplying said first descramble data to said user if it is possible.

13. A server according to claim 11, wherein said control unit controls further processes of:
encrypting information said plurality of shows by use of a first scramble, and outputting said scrambled information to said network; and
when said control unit receives a request to send descramble data for descrypting said first scramble through said network connection unit, deciding if said offering of service is possible on the basis of the identification information of said user, and supplying said first descramble data to said user if it is decided possible.

14. A server according to claim 12, wherein said control unit controls further processes of:
when said control unit receives channel switching information and a request to send descramble data for decrypting a second scramble by which data of said channel is encrypted, deciding if said offering of service is possible on the basis of the identification information of said user, supplying said second descramble data or requesting a firm for distributing data signal of said channel to send said second descramble data to said user if it is decided possible.
